(19) United States
(12) Patent Application Publication
(10) Pub. No.: US 2007/0266554 A1
(43) Pub. Date: Nov. 22, 2007

(54) ELECTROCHEMICAL CELL WITH MODERATE-RATE DISCHARGING CAPABILITY AND METHOD OF PRODUCTION

(76) Inventor: Gregg C. Bruce, Vancouver (CA)

Correspondence Address: MCANDREWS HELD & MALLOY, LTD, 500 WEST MADISON STREET, SUITE 3400, CHICAGO, IL, 60661, US

(21) Appl. No.: 11/383,641

(22) Filed: May 16, 2006

(51) Int. Cl. B05D 5/12; H01M 6/00

(52) U.S. Cl. 29/623.3; 427/122

(57) ABSTRACT

A method of forming cathode comprises (a) combining carbon and an active cathode material to form a dry mix; (b) mixing a binding material with a solvent to produce a first solution; (c) mixing a surfactant material with the first solution to form a combined solution; (d) combining the dry mix and the combined solution to form a paste; and (e) laminating the paste onto an expanded mesh aluminum current collector to form an cathode. A method of forming an electrochemical cell further comprises (f) laminating an active anode material on a current collector to form an anode; (g) mounting the anode and the cathode on opposite sides of a separator to form an electrode assembly; (h) encasing the electrode assembly within a housing and (i) filling at least a portion of the housing interior with an electrolyte.

### FIELD OF THE INVENTION

In general, the technology relates to electrochemical cells and in particular the technology relates to manufacturing an electrochemical cell with the ability to discharge at moderate rates.

### BACKGROUND OF THE INVENTION

Solid cathode/alkali metal anode electrochemical cells or batteries are used in applications ranging from power sources for implantable medical devices to down-hole instrumentation in oil/gas well drilling. Typically these batteries are made up of a housing, a positive electrode, a negative electrode, a non-aqueous electrolyte solution and a separator material between the electrodes. Due to the numerous applications for these types of batteries, this has been an active area of research.

One such battery uses poly(carbon monofluoride) as the active cathode material and lithium metal as the active anode material. Lithium poly(carbon monofluoride) (Li(CF)ₓ) batteries have been an active area of research and production for several decades because of their high energy density (Wh/1) and specific energy (Wh/kg). A high energy density and specific energy allows more energy to be extracted from the battery per unit of battery weight or volume.

However, one drawback of the Li(CF)ₓ is that performance is generally limited to low rates due to carbon monofluoride being an insulator. It is possible to make an electrochemical cell more conductive by adding a conductant. In order to add a conductant it is usually desirable to reduce the amount of carbon monofluoride. Since carbon monofluoride is the active cathode material, a reduction in carbon monofluoride reduces the energy density and specific energy. A change in cathode current collector, rather than cathode material, can reduce cathode resistance.

In Li(CF)ₓ batteries the poly(carbon monofluoride) is attached to a current collector using a binder. Originally, all Li(CF)ₓ batteries were manufactured using titanium or 446-stainless steel expanded metal mesh as the cathode current collector. Both of these metals are expensive, which increases the overall cost of the chemical cell. Moreover they do not act to significantly reduce cathode resistance.

Another previous approach used an aluminum foil current collector with the cathode material coated on one side. This was done because aluminum has a lower resistance than titanium or 446-stainless steel. This approach does reduce cathode resistance. However, other problems remain. Since only a single side of the aluminum current collector is coated, the aluminum faces the stainless steel housing. The aluminum is positively charged and the housing negatively charged which can lead to short circuits in the electrochemical cell.

In order to avoid the problems associated with only coating one side of the aluminum foil current collector, manufacturers began coating both sides. However, this method requires that both sides of the foil be coated with the active cathode material separately. This requires two separate passes during the manufacturing process, which increases manufacturing time and cost.

When aluminum foil is used the active cathode material is dissolved in an organic solvent prior to application. This is true regardless of whether one side is coated or both sides are coated. Water cannot be used. The inability to use water as a solvent adds cost and difficulty to the manufacturing process.

Accordingly, it would be desirable to provide a cathode with reduced resistance and the ability to discharge at moderate rates. It is also desirable to form the cathode with active cathode material on both sides of the current collector using a single pass during coating of the active cathode material and water as a solvent for the active cathode material.

### SUMMARY OF THE INVENTION

A method of forming an electrode comprises (a) combining carbon and an active electrode material to form a dry mix; (b) mixing a binding material with a solvent to produce a first solution; (c) mixing a surfactant material with the first solution to produce a combined solution; (d) combining the dry mix and the combined solution to form a paste; (e) laminating the paste onto an expanded mesh aluminum current collector to form an electrode. These steps can be performed sequentially or in a different order.

The active electrode compound can be poly(carbon monofluoride). The binding material can be polytetrafluoroethylene (PTFE). The surfactant material can be sodium lauryl sulfate. The electrode can be a cathode.

A method of forming an electrochemical cell comprises (a) combining carbon and an active cathode material to form a dry mix; (b) mixing a binding material with a solvent to produce a first solution; (c) mixing a surfactant material with the first solution to produce a combined solution; (d) combining the dry mix and the combined solution to form a paste; (e) laminating the paste onto an expanded mesh aluminum current collector to form a cathode; (f) laminating an active anode material on a current collector to form an anode; (g) mounting the anode and the cathode on opposite sides of a separator to form an electrode assembly; (h) encasing the electrode assembly within a housing such that the anode faces the housing interior surface, the anode interposed between the active cathode material and the housing; (i) filling at least a portion of the housing interior with an electrolyte. These steps can be performed sequentially or in a different order.

The active anode material can be selected from the group consisting of lithium, sodium, calcium, potassium and alloys thereof. The electrolyte can comprise at least one of propylene carbonate, tetrahydrofuran and a mixture of dimethyoxyethane with lithium perchlorate. Alternatively the electrolyte can comprise a mixture of propylene carbonate, tetrahydrofuran and the mixture of dimethyoxyethane with lithium perchlorate.

The electrode assembly can be spiral wound prior to encasing the electrode assembly within the housing.

An electrode comprises an expanded mesh aluminum current collector having laminated thereon a paste formed by combining (a) a dry mix comprising carbon and an active electrode material, (b) a first solution comprising a binding material and a first solvent, and (c) a surfactant material.

The active electrode material can be poly(carbon monofluoride). The binding material can be PTFE. The surfactant material can be sodium lauryl sulfate. The electrode can be a cathode.

An electrode assembly comprises (a) a cathode; (b) an anode comprising an active anode material laminated on a current collector; (c) a separator interposed between the anode and the cathode. The cathode comprises an expanded mesh aluminum current collector having laminated thereon a paste formed by combining (1) a dry mix comprising carbon and an active cathode material, (2) a first solution comprising a binding material and a first solvent, and (3) a combined solution comprising a surfactant material and the first solution.

The active cathode material can be polycarbon monofluoride. The binding material can be PTFE. The surfactant material can be sodium lauryl sulfate. The active anode material can be selected from the group consisting of lithium, sodium, calcium, potassium and alloys thereof.

An electrochemical cell comprises (a) a housing having an interior surface; (b) an electrode assembly; and (c) an electrolyte. The electrode assembly comprises: (1) a cathode (2) an anode comprising an active anode material laminated on a current collector; and (3) a separator interposed between the anode and the cathode. The cathode comprises an expanded mesh aluminum current collector having laminated thereon a paste formed by combining (i) a dry mix comprising carbon and an active cathode material, (ii) a first solution comprising a binding material and a first solvent, and (iii) a combined solution comprising a surfactant material and the first solution. The electrode assembly is encased within the housing such that the anode faces the housing interior surface, the anode is interposed between the active cathode material and the housing; and at least a portion of the housing interior is filled with the electrolyte.

The active cathode material can be poly(carbon monofluoride). The binding material can be PTFE. The surfactant material can be sodium lauryl sulfate. The active anode material can be selected from the group consisting of lithium, sodium, calcium, potassium and alloys thereof. The electrolyte can comprise at least one of propylene carbonate, tetrahydrofuran and a mixture of dimethyoxyethane with lithium perchlorate. Alternatively, the electrolyte comprises a mixture of propylene carbonate, tetrahydrofuran and the mixture of dimethyoxyethane with lithium perchlorate.

The electrode assembly can be spiral wound.

The electrochemical cell can further comprise a feed-through assembly operatively connected to the housing, the feed-through assembly comprising a conductive pin electrical contacting the cathode and an insulating glass cylinder surrounding the conductive pin. The insulating glass cylinder can be selected from the group consisting of aluminasilicate glasses and calcium-boro-aluminate glasses. The conductive pin can be formed from molybdenum.

### BRIEF DESCRIPTION OF THE PREFERRED EMBODIMENT(S)

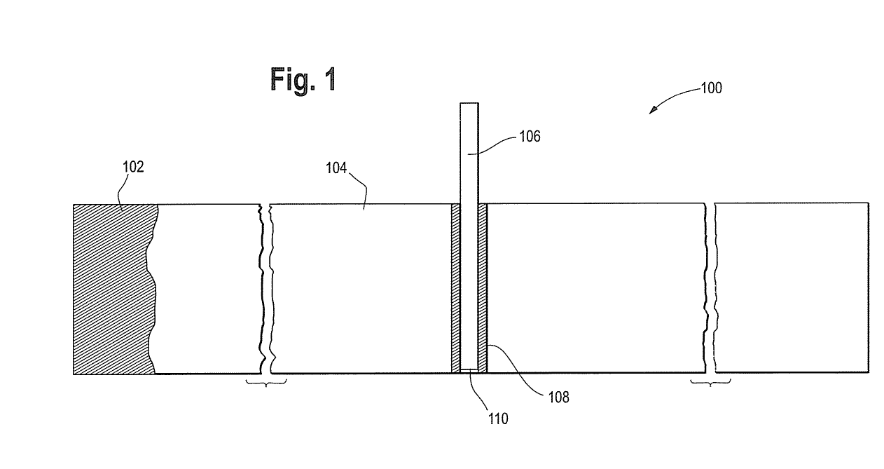

FIG. 1 is a partially cut away side view of a cathode of the current electrochemical cell.

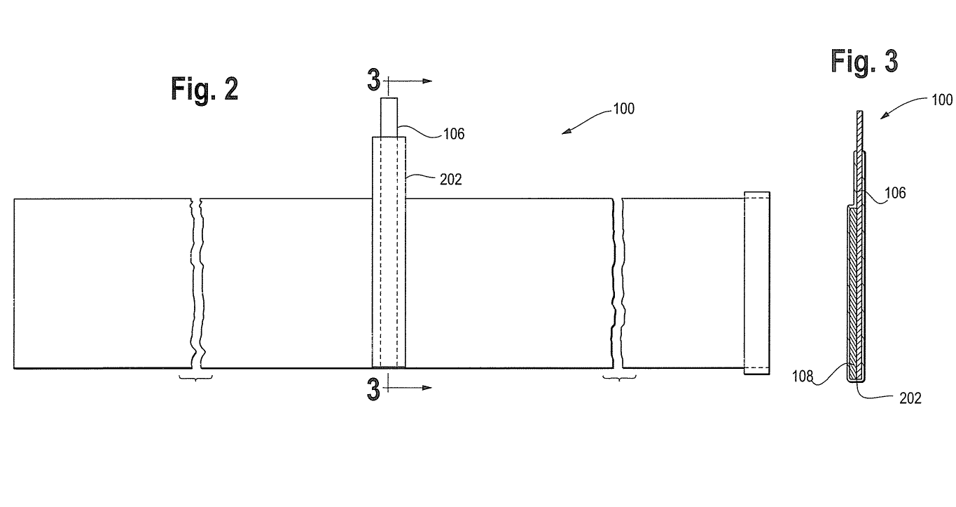

FIG. 2 is a side view of a cathode of the current electrochemical cell.

FIG. 3 is a cross sectional view of a cathode of the current electrochemical cell.

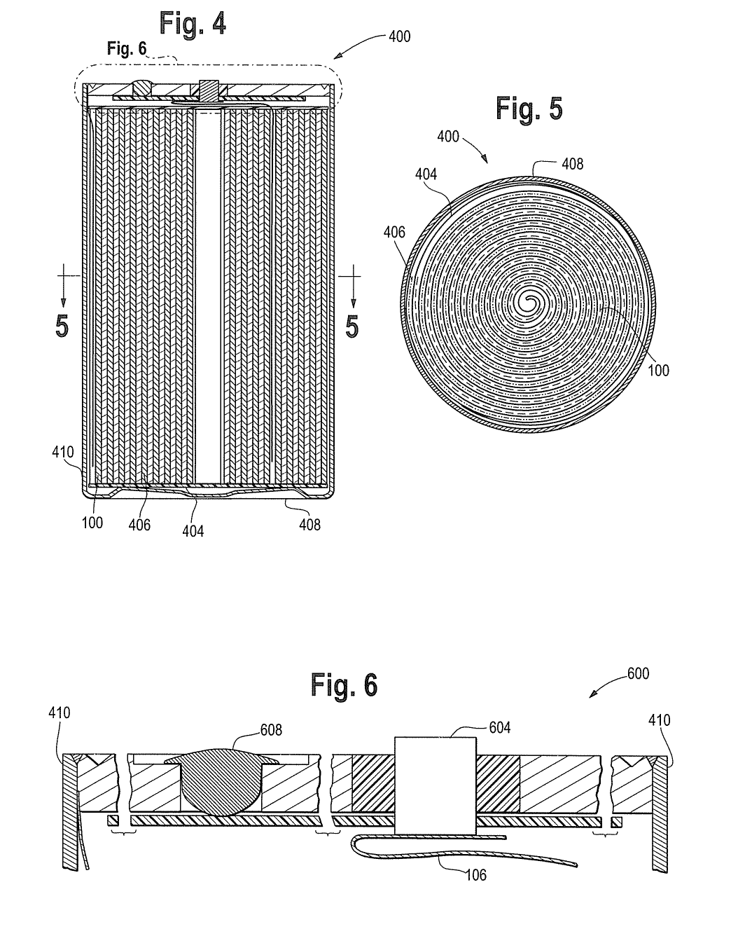

FIG. 4 is a cross sectional side view of the current electrochemical cell in a spiral wound configuration.

FIG. 5 is a cross sectional top view of the current electrochemical cell in a spiral wound configuration.

FIG. 6 is a cross sectional view of the feed through assembly of the current electrochemical cell.

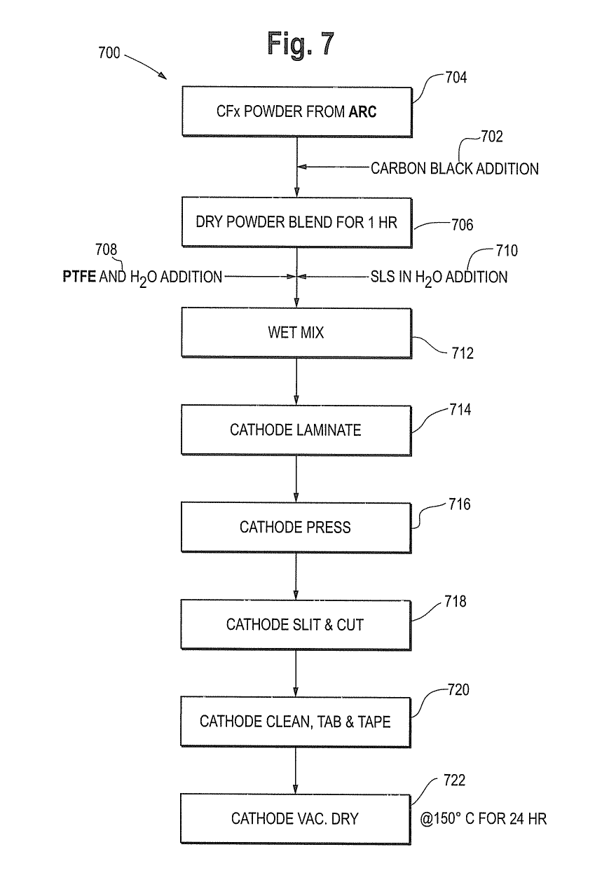

FIG. 7 is a flow diagram of the process for producing an electrode structure including a poly(carbon monofluoride) active carbon layer formed on an aluminum metal mesh current collector.

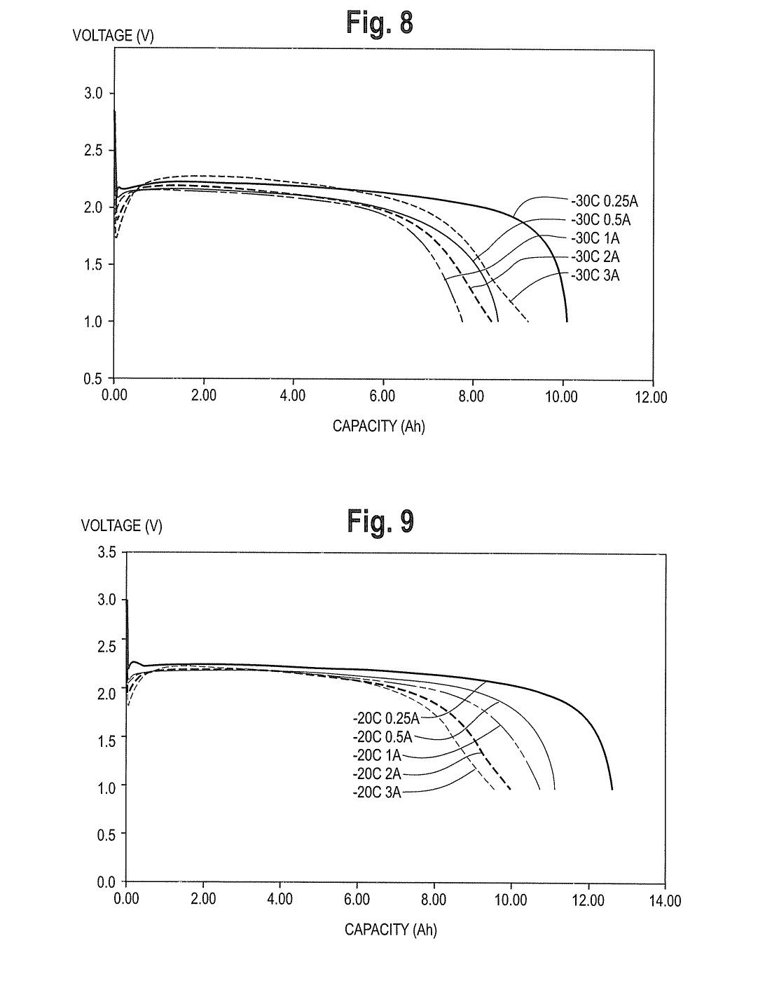

FIG. 8 is a graph of voltage in (V) vs. capacity in ampere-hours (Ah) for the current electrochemical cell at −30° C. (−22° F.).

FIG. 9 is a graph of voltage in (V) vs. capacity in ampere-hours (Ah) for the current electrochemical cell at −20° C. (−4° F.).

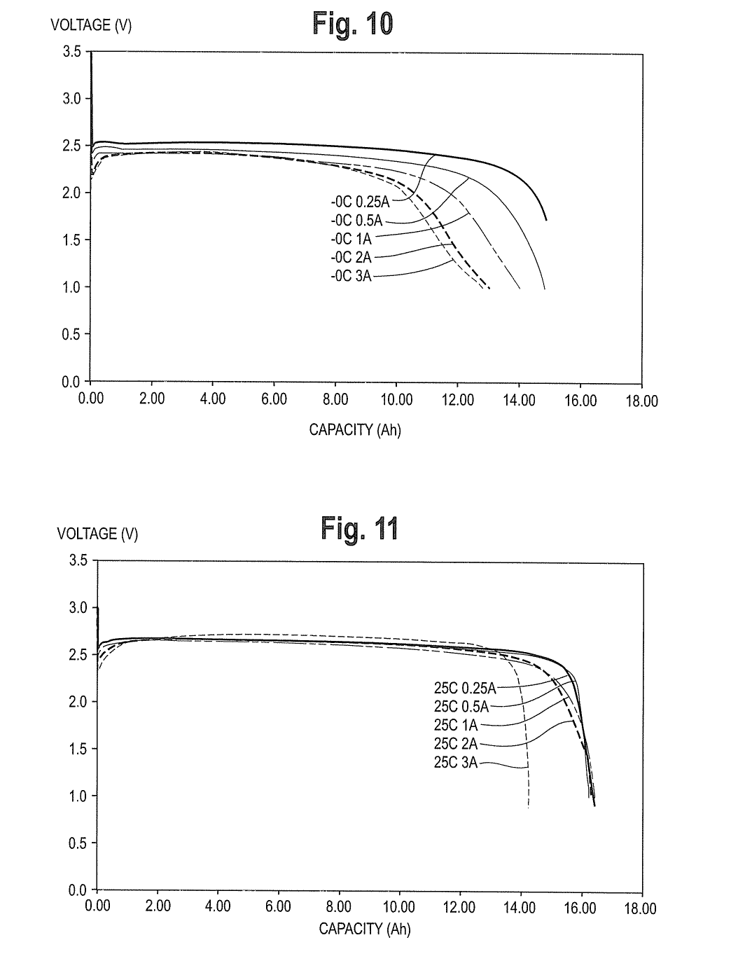

FIG. 10 is a graph of voltage in (V) vs. capacity in ampere-hours (Ah) for the current electrochemical cell at 0° C. (−32° F.).

FIG. 11 is a graph of voltage in (V) vs. capacity in ampere-hours (Ah) for the current electrochemical cell at 25° C. (77° F.).

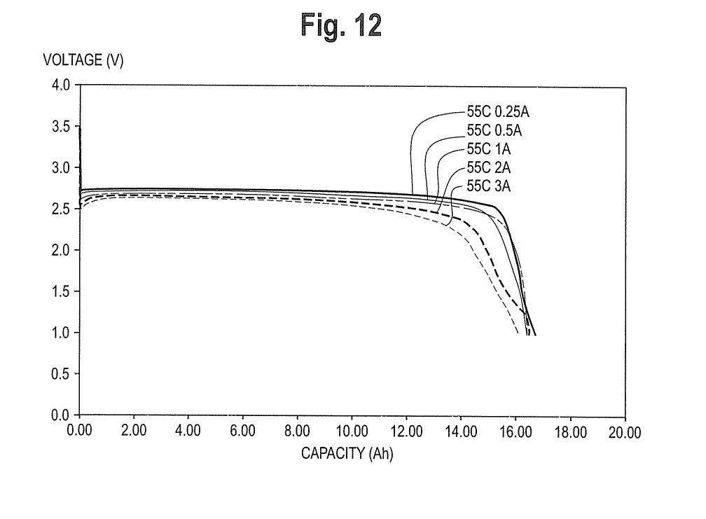

FIG. 12 is a graph of voltage in (V) vs. capacity in ampere-hours (Ah) for the current electrochemical cell at 55° C. (131° F.).

### DETAILED DESCRIPTION OF THE PREFERRED EMBODIMENT(S)

The current cathode possesses reduced resistance and the ability to discharge at moderate rates. The current method allows for production of the cathode with active cathode material on both sides of the current collector using a single pass during coating of the active cathode material and using water as a solvent for the active cathode material. A lithium poly(carbon monofluoride) battery will be used as an example. However, this is merely for purposes of illustration, not limitation.

FIG. 1 illustrates a cathode 100 of the current electrochemical cell. The cathode includes an aluminum expanded mesh current collector 102. Aluminum has a lower resistance than titanium or 446-stainless steel. This lower resistance reduces the overall resistance of the cell, allowing for higher discharge rates. The use of aluminum also reduces the overall cost of producing the cells since aluminum is not as costly as titanium or 446-stainless steel. Furthermore, aluminum is more malleable than titanium or 446-stainless steel making it easier to shape the cathode into the desired shape or configuration.

The current collector is laminated with an active cathode material 104. The expanded mesh current collector 102 is pressed into the active cathode material 104 so that the active cathode material 104 is forced through the openings of the collector. This laminates the active cathode material onto both sides of the expanded mesh current collector 102 in a single pass during manufacturing.

A preferred embodiment uses poly(carbon monofluoride) as the active cathode material. Poly(carbon monofluoride) can be combined with acetylene black, PTFE, sodium lauryl sulfate (SLS) and water to form a paste, which can be laminated onto the expanded mesh current collector 104.

Electrical contact between the cathode and the terminal of the cell can be obtained by using a extended cathode tab 106. A material such as aluminum can be used to form the cathode tab 106. The cathode tab 106 can be centered on the exposed portion of the current collector 108. The cathode tab 106 should not overlap the active cathode material 104 and the short end of the cathode tab 110 should not overhang the edge of the cathode 100. The cathode tab 106 can later be welded to the pin of the electrochemical cell to achieve electrical contact.

FIG. 2 illustrates a side view of a cathode 100 of the current electrochemical cell. The cathode tab 106 is affixed to the cathode 100 using tape 202. A PTFE tape can be used to affix the cathode tab.

FIG. 3 is a cross sectional view of a cathode 100 of the current electrochemical cell. This shows the cathode tab 106 attached to the exposed current collector 108 using tape 202. The tape 202 can be aligned with the cathode tab 106. The exposed current collector 108 and the cathode tab 106 can be covered by a single piece of tape 202 wrapped around the cathode.

FIG. 4 is a cross sectional side view of the current electrochemical cell 400 in a spiral wound configuration. The electrode is made up of a cathode 100 as described above. The cathode is connected to a separator 404. Possible separator materials include polypropylene and/or polyethylene electrolytic membranes. An anode 406 is attached to the opposite side of the separator 404. The separator 404 prevents contact between the cathode 402 and the anode 406. The anode 406 can be composed of lithium metal layered onto a current collector.

The electrode can then be mounted within a housing 408 to complete the electrochemical cell. The housing 408 if often made of stainless steel or titanium. The electrode is wound such that the lithium anode 406 is on the exterior portion of the electrode structure. This avoids the problem of short circuits caused by the negatively charged housing 408 and the positively charged aluminum of the cathode current collector 410 coming in contact with each other.

FIG. 5 is a cross sectional top view of the current electrochemical 400 cell in a spiral wound configuration. The cathode 100, separator 404 and anode 406 are spirally wound and placed inside a housing 410.

FIG. 6 is a cross sectional view of the feed through assembly 600 of the current electrochemical cell. The feed through assembly is connected to the top of the housing assembly. The feed through assembly 600 provides an electrically conductive pathway from the anode or cathode to the exterior of the case and provides a hermetic seal. The feed through assemble acts to isolate the electrode from the metal housing. In a preferred embodiment the cathode tab 106 is welded to a pin 604, forming an electrical connection. A possible pin 604 material is molybdenum. The pin 604 is isolated from the metal housing 410 by an insulating glass 608 surrounding the pin 604 and attached to the housing 410. Possible insulating glass materials include aluminasilicate glasses and calcium-boro-aluminate glasses. One possible aluminasilicate glass is produced by Sandia and is called Ta-23 glass. One possible calcium-boro-aluminate glass is also produced by Sandia and is known as Cabal-12 glasses. Both glasses have similar thermal coefficients of expansion as molybdenum so when the battery sees different temperatures there is no leakage. The aluminasilicate glasses and calcium-boro-aluminate glasses are effective within a stainless steel and titanium housing respectively.

FIG. 8 is a graph of voltage in volts (V) vs. capacity in ampere-hours (Ah) for a lithium poly(carbon monofluoride) electrochemical cell employing the current technology at −30° C. (−22° F.). At −30° C. (−22° F.) the current electrochemical cell shows discharge capacities of 8.32 ampere hours (Ah) at 0.25 amperes (A) of current, 5.83 Ah at 0.5 A, 5.45 Ah at 1 A, 5.31 Ah at 2 A and 6.35 Ah at 3 A.

FIG. 9 is a graph of voltage in volts (V) vs. capacity in ampere-hours (Ah) for a lithium poly(carbon monofluoride) electrochemical cell employing the current technology at −20° C. (−4° F.). At −20° C. (−4° F.) the current electrochemical cell shows discharge capacities of 11.04 ampere hours (Ah) at 0.25 amperes (A) of current, 9.28 Ah at 0.5 A, 8.39 Ah at 1 A, 7.53 Ah at 2 A and 7.10 Ah at 3 A.

FIG. 10 is a graph of voltage in volts (V) vs. capacity in ampere-hours (Ah) for a lithium poly(carbon monofluoride) electrochemical cell employing the current technology at 0° C. (32° F.). At 0° C. (32° F.) the current electrochemical cell shows discharge capacities of 14.40 ampere hours (Ah) at 0.25 amperes (A) of current, 13.32 Ah at 0.5 A, 11.74 Ah at 1 A, 10.60 Ah at 2 A and 10.43 Ah at 3 A.

FIG. 11 is a graph of voltage in volts (V) vs. capacity in ampere-hours (Ah) for a lithium poly(carbon monofluoride) electrochemical cell employing the current technology at 25° C. (77° F.). At 25° C. (77° F.) the current electrochemical cell shows discharge capacities of 15.72 Ah at 0.25 A of current, 16.02 Ah at 0.5 A, 15.52 Ah at 1 A, 15.50 Ah at 2 A and 14.07 Ah at 3 A.

FIG. 12 is a graph of voltage in volts (V) vs. capacity in ampere-hours (Ah) for a lithium poly(carbon monofluoride) electrochemical cell employing the current technology at 55° C. (131° F.). At 55° C. (131° F.) the current electrochemical cell shows discharge capacities of 15.98 ampere hours (Ah) at 0.25 amperes (A) of current, 15.77 Ah at 0.5 A, 15.87 Ah at 1 A, 14.98 Ah at 2 A and 14.43 Ah at 3 A.

In one discharge test called a SINCGARS test the run time of the electrochemical cell is measured by applying the battery to a military radio known as a SINCGARS radio and measuring the run time. The test produced a run time of 61.35 hours for the current electrochemical cell. An identical test performed on a Li/SO₂ electrochemical cell not employing the current technology results in a run time of 32.5 hours.

FIG. 7 shows a flow diagram of the process for producing an electrode structure including a poly(carbon monofluoride) active carbon layer formed on an aluminum metal mesh current collector.

Carbon 702 and the active cathode material 704 are combined to form a dry mix 706. The preferred embodiment uses poly(carbon monofluoride) as the active material and acetylene black as the carbon source. After combination this dry mix is blended for one hour.

A binding solution 708 is also formed. A commonly used binding material is PTFE. However, this compound does not dissolve in water easily due to its non-polarity. For this reason organic solvents, such as polyvinylidine difluoride (PVDF), have previously been used.

Adding a surfactant solution 710 with the PTFE/water suspension improves the miscibility of carbon monofluoride. One possible surfactant is sodium lauryl sulfate (SLS). The SLS is dissolved in water to form a surfactant solution 710 which can be added to the binding solution 708 to help the PTFE dissolve. The ability to use water as a solvent carries many advantages. For example, the ready availability and low cost of using water as a solvent.

The dry mix, binding solution and surfactant solution are then combined to form a paste 712. Using a machine the paste is laminated 714 onto the aluminum metal mesh current collector. The current collector is pressed 716 into the paste. The raised portions of the mesh current collector act as grippers, holding the cathode material in place. The cathode material if pushed through the empty space in the current collector, which results in cathode material on both sides of the current collector after a single pass in manufacturing.

The cathode is slit in step 718 to create an exposed portion of the expanded metal mesh current collector. An aluminum cathode tab is them placed on the exposed metal mesh current collector and taped 720. An aluminum tab can be attached using a PTFE tape.

The cathode is dried in step 722. A vacuum drying method is typically used. In the preferred embodiment the cathode remains at 150° C. for 24 hours.

The cathode can then be mounted to an anode with a separator in between the two electrodes. A common anode is lithium metal mounted onto a current collector. Porous membranes formed from polypropylene and/or polyethylene are commonly used as separators.

The electrode structure can then be mounted in a housing. The double-sided cathode allows the lithium metal to face up against the housing. This is preferable to having the aluminum on the outside because the aluminum is positively charged and the casing is negatively charged which can lead to short circuits. The lithium and housing are both negatively charged which reduces the likelihood of short circuits when the lithium is on the outside.

The housing can then be filled with an electrolyte solution. One embodiment uses a 1:1:1 propylene carbonate:tetrahydrofuran:dimethyoxyethane mixture dissolved in 0.75 molar lithium perchlorate. The tetrahydrofuran offers low temperature performance.

Although a spiral wound electrode within a cylindrical housing has served as an example. Possible variations include electrodes attached in parallel in a rectangular housing or a button cell formation.

While particular elements, embodiments and applications of the present invention have been shown and described, it will be understood, of course, that the invention is not limited thereto since modifications can be made by those skilled in the art without departing from the scope of the present disclosure, particularly in light of the foregoing teachings.

What is claimed is:

1. A method of forming an electrode comprising the steps of:
(a) combining carbon and an active electrode material to form a dry mix;
(b) mixing a binding material with a solvent to produce a first solution;
(c) mixing a surfactant material with said first solution to produce a combined;
(d) combining said dry mix and said combined solution to form a paste;
(e) laminating said paste onto an expanded mesh aluminum current collector to form an electrode.

2. The method of claim 1 wherein said steps are performed sequentially.

3. The method of claim 1 wherein said active electrode compound is polycarbon monofluoride.

4. The method of claim 3 wherein said binding material is PTFE.

5. The method of claim 3 wherein the surfactant material is sodium lauryl sulfate.

6. The method of claim 1 wherein said electrode is a cathode.

7. A method of forming an electrochemical cell comprising the steps of:
(a) combining carbon and an active cathode material to form a dry mix;
(b) mixing a binding material with a solvent to produce a first solution;
(c) mixing a surfactant material with said first solution to produce a combined solution;
(d) combining said dry mix and said combined solution to form a paste;
(e) laminating said paste onto an expanded mesh aluminum current collector to form a cathode:
(f) laminating an active anode material on a current collector to form an anode;
(g) mounting said anode and said cathode on opposite sides of a separator to form an electrode assembly;
(h) encasing said electrode assembly within a housing such that said anode faces said housing interior surface, said anode interposed between said active cathode material and said housing;
(i) filling at least a portion of said housing interior with an electrolyte.

8. The method of claim 7 wherein said steps are performed sequentially.

9. The method of claim 7 where said active anode material is selected from the group consisting of lithium, sodium, calcium, potassium and alloys thereof.

10. The method of claim 7 where said electrolyte comprises at least one of propylene carbonate, tetrahydrofuran and a mixture of dimethyoxyethane with lithium perchlorate.

11. The method of claim 10 where said electrolyte comprises a mixture of propylene carbonate, tetrahydrofuran and said mixture of dimethyoxyethane with lithium perchlorate.

12. The method claim of 7 wherein said electrode assembly is spiral wound prior to encasing said electrode assembly within said housing.

13. An electrode comprising an expanded mesh aluminum current collector having laminated thereon a paste formed by combining (a) a dry mix comprising carbon and an active electrode material, (b) a first solution comprising a binding material and a first solvent, and (c) a surfactant material.

14. The electrode of claim 13 wherein said active electrode material is polycarbon monofluoride.

15. The electrode of claim 13 wherein said binding material is PTFE.

16. The electrode of claim 13 wherein the surfactant material is sodium lauryl sulfate.

17. The electrode of claim 13 wherein said electrode is a cathode.

18. An electrode assembly comprising:
(a) a cathode comprising an expanded mesh aluminum current collector having laminated thereon a paste formed by combining (1) a dry mix comprising carbon and an active cathode material, (2) a first solution comprising a binding material and a first solvent, and (3) a surfactant material;
(b) an anode comprising an active anode material laminated on a current collector;
(c) a separator interposed between said anode and said cathode.

19. The electrode assembly of claim 18 wherein said active cathode material is polycarbon monofluoride.

20. The electrode assembly of claim 19 wherein said binding material is PTFE.

21. The electrode assembly of claim 19 wherein the surfactant material is sodium lauryl sulfate.

22. The electrode assembly of claim 19 where said active anode material is selected from the group consisting of lithium, sodium, calcium, potassium and alloys thereof.

23. An electrochemical cell comprising:
(a) a housing having an interior surface;
(b) an electrode assembly comprising:
(1) a cathode comprising an expanded mesh aluminum current collector having laminated thereon a paste formed by combining (i) a dry mix comprising carbon and an active cathode material, (ii) a first solution comprising a binding material and a first solvent, and (iii) a surfactant material;
(2) an anode comprising an active anode material laminated on a current collector;
(3) a separator interposed between said anode and said cathode;
(c) an electrolyte;
wherein said electrode assembly is encased within said housing such that said anode faces said housing interior surface, said anode is interposed between said active cathode material and said housing; and at least a portion of said housing interior is filled with said electrolyte.

24. The electrochemical cell of claim 23 wherein said active cathode material is polycarbon monofluoride.

25. The electrochemical cell of claim 24 wherein said binding material is PTFE.

26. The electrochemical cell of claim 24 wherein the surfactant material is sodium lauryl sulfate.

27. The electrochemical cell of claim 24 where said active anode material is selected from the group consisting of lithium, sodium, calcium, potassium and alloys thereof.

28. The electrochemical cell of claim 24 where said electrolyte comprises at least one of propylene carbonate, tetrahydrofuran and a mixture of dimethyoxyethane with lithium perchlorate.

29. The electrochemical cell of claim 24 where said electrolyte comprises a mixture of propylene carbonate, tetrahydrofuran and said mixture of dimethyoxyethane with lithium perchlorate.

30. The electrochemical cell of claim of 24 wherein said electrode assembly is spiral wound.

31. The electrochemical cell of claim 24 further comprising a feed-through assembly operatively connected to said housing, said feed-through assembly comprising a conductive pin electrical contacting said cathode and an insulating glass cylinder surrounding said conductive pin.

32. The electrochemical cell of claim 31 wherein said insulating glass cylinder is selected from the group consisting of aluminasilicate glasses and calcium-boro-aluminate glasses.

33. The electrochenical cell of claim 32 wherein said conductive pin is formed from molybdenum.
